(19) United States
(12) Patent Application Publication
(10) Pub. No.: US 2023/0270059 A1
(43) Pub. Date: Aug. 31, 2023

(54) APPARATUS TO REGULATE FLOW OF FLUID THROUGH DRIP IRRIGATION DEVICE

(71) Applicant: Israel RUTTENBERG, Littleton, CO (US)

(72) Inventor: Israel RUTTENBERG, Littleton, CO (US)

(21) Appl. No.: 18/312,163

(22) Filed: May 4, 2023

Related U.S. Application Data
(63) Continuation-in-part of application No. 17/145,365, filed on Jan. 10, 2021, now abandoned.

(51) Int. Cl. A01G 25/02

(52) U.S. Cl. CPC A01G 25/02

(57) ABSTRACT

Embodiments of the present invention provide an apparatus to regulate flow of an irrigation fluid through a drip irrigation device. The apparatus includes a fluid supply conduit, a rigid insert mounted coaxially within the fluid supply conduit, and at least one elastomeric ring. The rigid insert receives the fluid from a fluid supply at an inlet port and guides the fluid from the inlet port toward an outlet port. The at least one elastomeric ring is stretched over a portion of the rigid insert having a plurality of inflow gates inbuilt circumferentially into the rigid insert, where an elastomeric ring creates an inward pressure on each inflow gate that is lesser than an input pressure of the fluid. As a result, the flow of the liquid through a plurality of outlet perforations is regulated.

### FIELD OF THE INVENTION

The present invention relates generally to drip irrigation devices and more particularly to an apparatus to regulate the flow of fluid through a drip irrigation device.

### BACKGROUND OF THE INVENTION

Sensors, controllers, and irrigation device emitters are usually designed to enable agriculturists to achieve optimal conditions of soil for growth. Over-watering of soil may asphyxiate plant roots and create another form of stress. Sub-surface drip irrigation systems frequently expose roots to stress and increase risks of root intrusion, stunt plant growth, and impair production. On the other hand, low soil water availability results in root stress. It is therefore prudent to have an irrigation device emitter technology that provides efficient water delivery to conserve natural resources.

Several conventional irrigation device emitters exist that include supply conduits to communicate pressurized fluids. For example, U.S. Pat. No. 6,039,270 teaches a method wherein drip emitters of a supply conduit include a pressure compensating flow regulating diaphragm. Such pressure compensating diaphragm utilizes complex flow passage algorithms and small gates to provide regulated flow emissions through perforations within said supply conduit. However, the complexity fails to meet varying pressure supply levels of the fluid and fails to compensate for losses that occur during the passage of the fluid at ultra low flow rates.

Another U.S. Pat. No. 5,294,058 teaches disk-shaped or flat elastomeric membranes for regulating the flow of fluids. However, such membranes are not feasible in the long run and lead to other performance limitations. In yet another example, as disclosed in U.S. Pat. No. 4,846,406, to regulate the flow rate of pressurized fluid at 2-30 gallons per hour, a deforming elastomeric encasing component is provided that communicates internally with angled protrusions of a tubular rigid insert. However, this prior art merely discloses an elastomeric encasing component that is stretched and clamped to a plastic pin present at a puncture in a delivery main line to reduce flow. The prior art does not facilitate controlling the flow at various positions along the delivery line to achieve an efficient flow rate.

Accordingly, to meet the aforementioned drawbacks, an alternate apparatus for controlling the flow rate in a drip irrigation emitter is needed. The alternate apparatus must also provide flow-regulating effects at varying pressure levels of the fluid.

### SUMMARY OF THE INVENTION

An aspect of the invention provides an apparatus to regulate the flow of a fluid through a drip irrigation device. The apparatus includes a fluid supply conduit, a rigid insert mounted coaxially within the fluid supply conduit, and at least one elastomeric ring. The rigid insert receives the fluid from a fluid supply at an inlet port and guides the fluid from the inlet port toward an outlet port. The at least one elastomeric ring is stretched over a portion of the rigid insert having a plurality of inflow gates inbuilt circumferentially into the rigid insert, wherein an elastomeric ring creates an inward pressure on each inflow gate that is lesser than an input pressure of the fluid. To regulate the flow of the fluid, a plurality of outlet perforations is provided at predefined locations on circumference of the fluid supply conduit. In an example, the at least one elastomeric ring exhibits a plurality of apertures in response to a plurality of differential pressures existing between an inward pressure exerted on the plurality of inflow gates and the input pressure at which the fluid enters the inlet port. As a result, the flow of the liquid through the plurality of outlet perforations is regulated.

The at least one elastomeric ring creates the inward pressure on the plurality of inflow gates, based on at least one of a diameter of the at least one elastomeric ring, a thickness, durability, and an ultraviolet resistance of a material used within the elastomeric ring. Typically, a total inward pressure applied on the fluid within the apparatus, is based on a number of elastomeric rings positioned on the rigid insert, and a position of each elastomeric ring.

The rigid insert has a plurality of radially fixed obstructions (hereinafter referred to as a plurality of ridges) affixed at a plurality of locations around a circumference of the rigid insert. The radially fixed obstructions obstruct a flow of the fluid that passes through a space between the rigid insert and the fluid supply conduit. Each radially fixed obstruction runs around the circumference of the rigid insert. Typically, an elastomeric ring is positioned between a pair of adjacent radially fixed obstructions (or ridges). When the fluid flows through the apparatus, the rigid insert in communication with the at least one elastomeric ring, the plurality of inflow gates, and the plurality of ridges creates a pressure responding diaphragm that seals a communication with the fluid supply conduit and regulates a flow of the fluid passing through the rigid insert and in a space between the rigid insert and the fluid supply conduit.

In an example, the pressure responding diaphragm operates between adjacent radially fixed obstructions provided on the circumference of the rigid insert, at least one elastomeric ring, and the fluid supply conduit. The pressure responding diaphragm gets deflected based on the inward pressure applied by the at least one elastomeric ring, that in turn reduces or increases the space available between the rigid insert and the fluid supply conduit, thereby decreasing or increasing the flow of the fluid respectively. In an embodiment, the at least one elastomeric ring exerts the inward pressure on the plurality of inflow gates, based on at least one of the diameter of the at least one elastomeric ring, a thickness, durability, and ultraviolet resistance of a material used for making the at least one elastomeric ring.

In an embodiment, the fluid supply conduit comprises an extruded transparent casing having a plurality of outlet perforations on an external surface, to facilitate the exit of the fluid, wherein the fluid exists at a flow rate regulated by the apparatus as described above.

### BRIEF DESCRIPTION OF DRAWINGS

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device, or a tool and instrumentalities disclosed herein. Moreover, those in the art will understand that the drawings are not to scale. Wherever possible, like elements have been indicated by identical numbers.

FIG. 1 is a front view of an apparatus that regulates a flow of a fluid through a drip irrigation device, according to an embodiment of the present disclosure;

FIG. 2 is an exploded view of a portion of the apparatus of FIG. 1, depicting the positioning of an elastomeric ring on a rigid insert, in accordance with an embodiment of the present disclosure;

FIG. 3 is a sectional view of a portion of the apparatus of FIG. 1, illustrating a plurality of inflow gates covered by the elastomeric ring of FIG. 2, in accordance with an embodiment of the present disclosure;

FIG. 4A is a perspective view the apparatus of FIG. 1, having one elastomeric ring, in accordance with an embodiment of the present disclosure;

FIG. 4B is a perspective view the apparatus of FIG. 1, having two elastomeric rings, in accordance with an embodiment of the present disclosure;

FIG. 4C is a perspective view the apparatus of FIG. 1, having three elastomeric rings, in accordance with an embodiment of the present disclosure; and

FIG. 5 is a perspective view of the apparatus depicting a transparent extruded casing, in accordance with an embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The present invention is related to an apparatus to regulate the flow of irrigation fluid through a drip irrigation device.

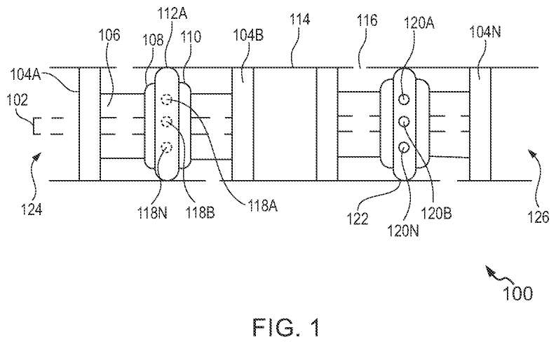

Various embodiments of the present invention are described hereinafter with reference to FIG. 1 to FIG. 5.

As shown in FIG. 1, an apparatus 100 includes a rigid insert 106 having an inlet port 124 and an outlet port 126, at least one elastomeric ring 112A, a fluid supply conduit 114, a plurality of radially fixed obstructions (hereinafter interchangeably referred to as a “plurality of ridges 108, 110”), an outlet perforation 116, a plurality of inflow gates 118A-118N, an outlet perforation 116, and one or more circular rigid obstructions 104A-104N. The rigid insert 106 is placed within the fluid supply conduit 114. In FIG. 1, only one outlet perforation 116 is shown, however in practice a plurality of outlet perforations is provided on the circumference of the fluid supply conduit 114 to facilitate the emission of a fluid 102 in a drip-wise manner. Similarly, while only two ridges 108, 110 are shown in FIG. 1, more than two ridges can be provided on the circumference of the rigid insert 106 at predefined distances along a length of the rigid insert 106. The rigid insert 106, the plurality of ridges 108, 110, and the fluid supply conduit 114 are made of polyethylene plastic.

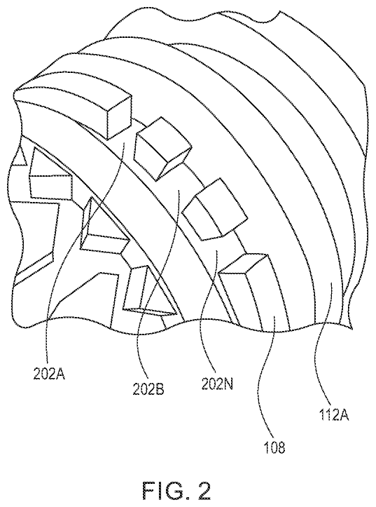

As shown, the fluid 102 (hereinafter interchangeably referred to as “the pressurized fluid 102”), is inputted into the rigid insert 106 at the inlet port 124 and is passed through the rigid insert 106 to exit at the outlet port 126. In an embodiment, the rigid insert 106, is a hollow tubular structure mounted coaxially and internally to the fluid supply conduit 114. The fluid 102 which can be an irrigating fluid is provided from a fluid supply at the inlet port 124 and is made to pass internally through a hollow space of the rigid insert 106. The rigid insert 106 has the plurality of ridges (e.g., 108, 110) provided at a plurality of locations around a circumference of the rigid insert 106. The plurality of ridges (e.g., 108, 110) obstructs a flow of the fluid 102 as it passes through a space between the rigid insert 106 and the fluid supply conduit 114. The ridge 108 may include a plurality of channels 202A-202N, as shown in FIG. 2. The fluid 102 meets with resistance when passing through the multiple channels 202A-202N of the ridge 108.

Further, the at least one elastomeric ring 112A is stretched over the rigid insert 106 in a space available between a pair of adjacent radially fixed obstructions for example, a pair of adjacent ridges (e.g., 108, 110). The at least one elastomeric ring 112A is composed of at least one of a non-degradable natural rubber, synthetic rubber, silicone rubber, and other such similar materials. In an embodiment, the at least one elastomeric ring 112A is in form of rubber tubing. In an example, the at least one elastomeric ring 112A when designed to be in a form of silicone rubber tubing with thickness of about 0.04 to 0.10 inches, has proven to be optimum in regard to durability in operation and resistance against wear and tear. Generally, for ensuring an optimum fit of the at least one elastomeric ring 112A, a diameter of the tubing is maintained slightly lesser than a diameter of the fluid supply conduit 114. This ensures that the at least one elastomeric ring 112A is stretched over and firmly clamped onto the rigid insert 106.

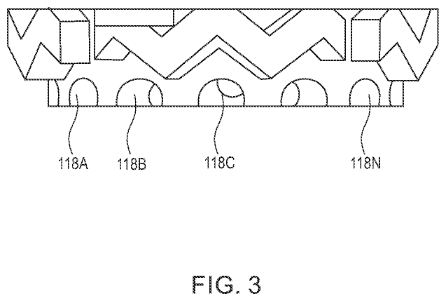

During assembly, the at least one elastomeric ring 112A is stretched over the rigid insert 106 and is then inserted into the fluid supply conduit 114 during the extrusion of the fluid supply conduit 114. Typically, the at least one elastomeric ring 112A is stretched over the rigid insert 106 in such a manner, that an inward force is exerted on the plurality of inflow gates 118A-118N. A sectional view of the plurality of inflow gates 118A-118N is shown in FIG. 3. The plurality of inflow gates 118A-118N includes perforations of a predefined size provided around a circumference of the rigid insert 106. The at least one elastomeric ring 112A creates an inward pressure on each inflow gate (e.g., 118A) that is lesser than an input pressure of the fluid 102, which helps in regulating a flow of the fluid 102.

In operation, the at least one elastomeric ring 112A, exhibits a plurality of apertures in response to a plurality of differential pressures existing between the inward pressure exerted on the plurality of inflow gates 118A-118N, and the input pressure at which the fluid 102 enters the inlet port 124. Further, the inward pressure exerted by the at least one elastomeric ring 112A on the plurality of inflow gates 118A-118N is based on, but not limited, to the diameter of the elastomeric ring, a thickness, durability, and ultraviolet resistance of a material used for making at least one elastomeric ring 112A. Further, the total inward pressure exerted on the fluid 102 is also dependent on the number of elastomeric rings positioned on the rigid insert 106 and on the position of each elastomeric ring.

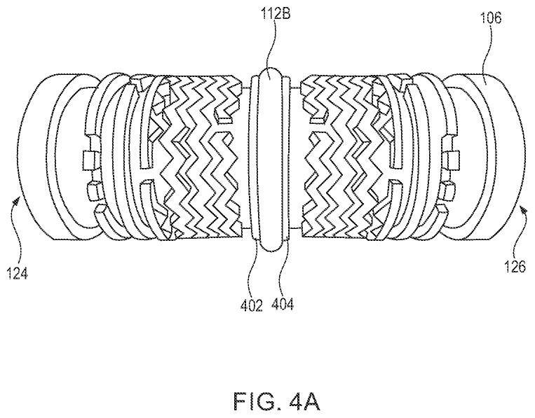

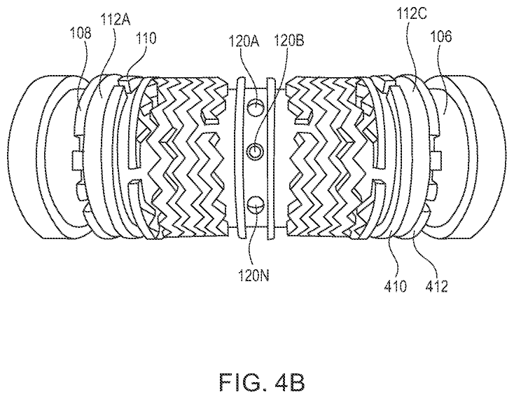

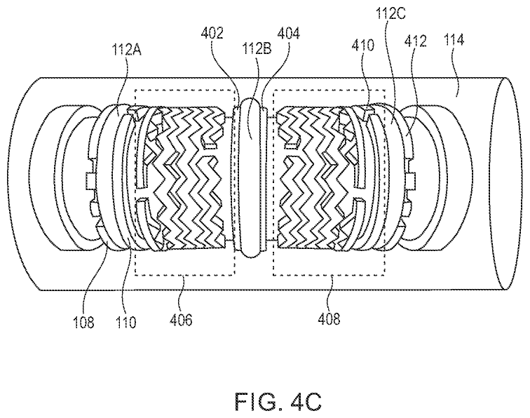

Provision for placing another elastomeric ring may be provided at a predefined distance from the at least one elastomeric ring 112A, and along a length of the rigid insert 106. Depending on a required regulation of the flow of the fluid 102, the other elastomeric ring may or may not be placed at a position 122. In an example, where no elastomeric ring is placed on the position 122 as shown in FIG. 1, a plurality of inflow gates 120A-120N existing at the position 122 is kept open for the flow of the fluid 102. Various combinations of a number of elastomeric rings are depicted in FIGS. 4A-4C. An embodiment having only one elastomeric ring is shown in FIG. 4A.

FIG. 4A depicts the rigid insert 106 having an elastomeric ring 112B positioned in a central portion and between two ridges 402, 404. It may be noted that typically the elastomeric ring (e.g., 112B) is placed around that region of the rigid insert 106 where pressure is required to be exerted on the fluid 102 that is passed through the rigid insert 106. As pressure on the fluid 102 is required in the central portion of the rigid insert 106, the elastomeric ring 112B is placed around a central circumferential portion of the rigid insert 106. In some embodiments, two elastomeric rings may be provided around the rigid insert 106. An embodiment having at least two elastomeric rings is shown in FIG. 4B.

FIG. 4B is a perspective view of the apparatus 100, having two elastomeric rings 112A and 112C. The elastomeric ring 112A is provided in a front portion of the rigid insert 106 to exert pressure when the fluid 102 enters the rigid insert 106. The other elastomeric ring 112C is provided near the rear portion of the rigid insert 106 to exert pressure on the fluid 102 during exit from the rigid insert 106. The central portion of the rigid insert 106 is left open without an elastomeric ring, as no pressure is required to be exerted on the fluid 102 in the central portion of the rigid insert 106. Accordingly, the plurality of inflow gates 120A-120N is kept open, so that the fluid 102 can effuse from the interior of the rigid insert 106 toward the fluid supply conduit 114. In yet another embodiment, three elastomeric rings may be provided on the rigid tubular insert 106 as shown in FIG. 4C.

FIG. 4C is a perspective view of the apparatus 100 having three elastomeric rings 112A-112C. As shown the elastomeric ring 112A is provided around the front portion, between the adjacent ridges 108 and 110, the elastomeric ring 112B is provided around the central portion between the adjacent ridges 402 and 404, and the elastomeric ring 112C is provided at rear portion of the rigid insert 106 between adjacent ridges 410 and 412. Accordingly, the pressure on the fluid 102 will be exerted in the front, central and rear portions of the rigid insert 106.

Due to the inward force exerted by the elastomeric rings 112A-112C, two pressure responding diaphragms 406, 408 are created along the length of the rigid insert 106, which seals communication with the fluid supply conduit 114. A first pressure responding diaphragm 406 is formed between the elastomeric rings 112A and 112B, the plurality of ridges 110, 402 present between the elastomeric rings 112A and 112B on the circumference of the rigid insert 106, and the fluid supply conduit 114. A second pressure responding diaphragm 408 is formed between the elastomeric rings 112B and 112C, the plurality of ridges 404, 410 present between the elastomeric ring 112B and the elastomeric ring 112C on the circumference of the rigid insert 106 and the fluid supply conduit 114. Each of the pressure responding diaphragms 406, 408 act as a valve that opens or closes based on the input pressure, and thereby controls the flow of the fluid 102. In other words, the pressure responding diaphragms 406, 408, seal a communication with the fluid supply conduit 114 and thereby regulate the flow of the fluid 102 passing through a space between the rigid insert 106 and the fluid supply conduit 114.

When pressure is applied on one side of the pressure responding diaphragm 406, it deflects causing a volume of a chamber or space present between the rigid insert 106 and the fluid supply conduit 114 to increase or decrease depending on a direction of the deflection. A change in volume alters the pressure inside the chamber, which in turn affects the flow of the fluid 102 through the apparatus 100. For example, when an input pressure is high, the pressure responding diaphragm 406 deflects to reduce the volume of the chamber and thereby lowers the pressure. As a result, the valve present between the elastomeric ring 112A and the plurality of inflow gates 118A-118N opens and the fluid 102 flows through the apparatus 100 at a reduced rate. Conversely, when an input pressure is low, the pressure responding diaphragm 406 deflects in an opposite direction, which increases the volume of the chamber thereby raising the pressure. As a result, the valve closes, which in turn restricts the flow of the fluid 102 through the apparatus. A similar operation occurs with the elastomeric rings 112B and 112C.

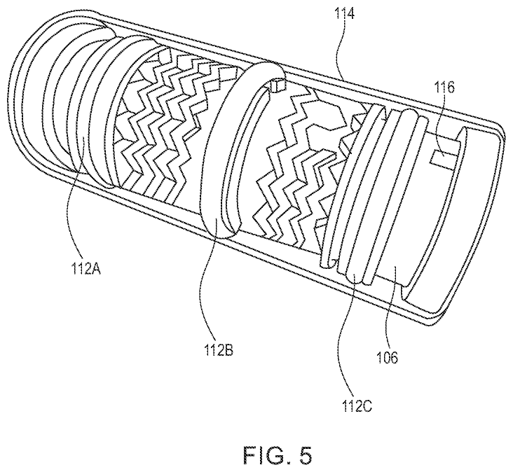

It may be noted that the pressure responding diaphragms 406, 408 respond to the pressure present within the elastomeric rings 112A-112C. Further, the pressure generated by the elastomeric rings 112A-112C results in the fluid 102 being emitted through the plurality of outlet perforations (e.g., 116) in a regulated manner. A perspective view of the outlet perforation 116 is shown in FIG. 5.

FIG. 5 is a perspective view of the apparatus 100 having an extruded encasing (e.g., a transparent encasing) as the fluid supply conduit 114, in accordance with an embodiment of the present disclosure. The transparent extruded casing 114 enables visualization of the flow of the fluid 102 through and around the rigid insert 106. Further, the fluid supply conduit 114 or the extruded casing as shown in FIG. 5, has the outlet perforations 116 on an external surface to facilitate the exit of the fluid 102 from the apparatus 100. In an example, the flow rate of the fluid achievable in the disclosed apparatus 100 is 0.20 to 2 gallons per hour. In another example, the flow rate of the fluid 102 achievable is 0.01 to 0.1 gallons per hour. It is well understood by the present disclosure, that presence of multiple elastomeric rings 112A-112C about the rigid insert 106 helps to achieve extremely low flow rates of 0.01 gallons per hour. The ability to achieve such low flow rates of fluid helps in reducing water usage by 30-60 percent. Accordingly, drip irrigators inbuilt with the apparatus 100 would not only maintain low flow rates of irrigation fluid but would also sustain operations for longer durations of time, thereby providing a higher return on investment.

Embodiments of the apparatus can include every combination and permutation of various components and various processes, wherein one or more instances of the apparatus described herein can be operated asynchronously (e.g., sequentially), concurrently (e.g., in parallel), or in any other suitable order with another embodiment of the apparatus described herein.

As a person skilled in the art will recognize from the previous detailed description and from the figures and claims, modifications and changes can be made to the preferred embodiments of the invention without departing from the scope of this invention defined in the following claims.

What is claimed is:

1. An apparatus to regulate a flow of a fluid through a drip irrigation device, the apparatus comprising:
a fluid supply conduit;
a rigid insert, mounted coaxially within the fluid supply conduit, configured to receive the fluid from a fluid supply at an inlet port and guide the fluid from the inlet port towards an outlet port; and
at least one elastomeric ring stretched over a portion of the rigid insert having a plurality of inflow gates inbuilt circumferentially into the rigid insert, wherein an elastomeric ring creates an inward pressure on each inflow gate that is lesser than an input pressure of the fluid, to regulate the flow of the fluid through a plurality of outlet perforations provided at predefined locations on a circumference of the fluid supply conduit.

2. The apparatus of claim 1, wherein the rigid insert has a plurality of radially fixed obstructions provided at a plurality of locations around a circumference of the rigid insert to obstruct the flow of the fluid that passes through a space between the rigid insert and the fluid supply conduit.

3. The apparatus of claim 2, wherein each radially fixed obstruction runs around the circumference of the rigid insert.

4. The apparatus of claim 1, wherein the at least one elastomeric ring is positioned between a pair of adjacent radially fixed obstructions.

5. The apparatus of claim 2, wherein the rigid insert in communication with the at least one elastomeric ring, the plurality of inflow gates, and the plurality of radially fixed obstructions, creates a pressure responding diaphragm that seals the communication with the fluid supply conduit and regulates a flow of the fluid passing through the rigid insert and in the space between the rigid insert and the fluid supply conduit.

6. The apparatus of claim 5, wherein the pressure responding diaphragm operates between the plurality of radially fixed obstructions provided on the circumference of the rigid insert, at least one elastomeric ring, and the fluid supply conduit.

7. The apparatus of claim 1, wherein the at least one elastomeric ring exhibits a plurality of apertures in response to a plurality of differential pressures existing between inward pressure exerted on the plurality of inflow gates and the input pressure at which the fluid enters the inlet port.

8. The apparatus of claim 1, wherein the at least one elastomeric ring exerts the inward pressure on the plurality of inflow gates, based on at least one of a diameter of the at least one elastomeric ring, a thickness, durability, and ultraviolet resistance of a material used for making the at least one elastomeric ring.

9. The apparatus of claim 1, wherein a total inward pressure exerted on the fluid is dependent on a number of elastomeric rings positioned on the rigid insert and a position of each elastomeric ring.

10. The apparatus of claim 1, wherein the fluid supply conduit is an extruded encasing having the plurality of outlet perforations to facilitate exit of the fluid.
